(19) United States
(12) Patent Application Publication
(10) Pub. No.: US 2014/0252139 A1
(43) Pub. Date: Sep. 11, 2014

(54) PLASTIC ATOMIZING NOZZLE WITH INTEGRAL BODY AND OCCLUDER

(71) Applicant: Misty Mate, Inc., Tempe, AZ (US)

(72) Inventors: David Bandawat, Tempe, AZ (US); John Heiner, Tempe, AZ (US); Walter A. Salado, III, Tempe, AZ (US); Traci Feldman, Tempe, AZ (US)

(73) Assignee: Misty Mate, Inc., Tempe, AZ (US)

(21) Appl. No.: 14/198,278

(22) Filed: Mar. 5, 2014

Related U.S. Application Data
(60) Provisional application No. 61/772,908, filed on Mar. 5, 2013.

(51) Int. Cl. B05B 1/02

(52) U.S. Cl. CPC B05B 1/02
USPC 239/600; 239/589

(57) ABSTRACT

A nozzle for atomizing a fluid is particularly suited for misting systems and generates a mist without any moving parts. The nozzle may be completely plastic for corrosion resistance, and may have a body cast as a unitary plastic article. The body may have a substantially cylindrical neck and a head integral with the neck and having a cavity that receives an atomizing insert. An occluder integral with the head may extend into the cavity such that the insert fits over the occluder and leaves a gap between the insert and the occluder. A fluid conduit disposed through the center of the neck may deliver fluid to the cavity. The fluid conduit may narrow at it approaches the cavity to increase fluid pressure in the head. One or more apertures from the fluid conduit into the cavity may be narrower than the fluid conduit to again increase fluid pressure.

### FIELD OF INVENTION

This invention relates to fluid atomizing nozzles. This invention relates particularly to a corrosion-resistant atomizing nozzle having no moving parts.

### BACKGROUND

Atomizing nozzles are used in a wide variety of applications, including handheld spray bottles, supermarket produce moisteners, fire suppression systems, and the like. For example, misting systems are used to deliver a fine mist to an area around the misting system in order to cool the area. The mist comprises a fluid that is highly atomized so as to evaporate quickly and not collect on or saturate nearby surfaces and objects. To produce the mist, typically the fluid is fed under pressure through an atomizing nozzle. Most atomizing nozzles are brass or stainless steel. These materials are expensive and susceptible to corrosion, buildup of deposits, or both. An atomizing nozzle with an improved useful life over metal nozzles is needed.

In a typical nozzle, the fluid passes through a chamber to a relatively small aperture. The size difference and pressure causes atomization and ejection of the fluid. Most nozzles contain an impeller within the chamber. The impeller is freely moving in the chamber and impedes the movement of the fluid, breaking the flow and causing further atomization. Freely moving impellers increase the manufacturing cost of the nozzle because the impeller must be separately cast from the body. Impellers can be lost or broken, or may malfunction due to buildup of deposits on the impeller surface. Each of these drawbacks decreases the useful life of the nozzle. A nozzle that breaks the flow of fluid like an impeller but does not have internal moving parts is needed.

### SUMMARY OF THE INVENTION

A nozzle for atomizing a fluid may, according to embodiments described herein, have a body cast as a unitary article, preferably from plastic. The body may have a head and a threaded, barbed, or otherwise insertable neck integral with the head. The nozzle may install into a misting system or other atomized fluid delivery system by, for example, screwing the threaded neck into an emitter interface in the fluid delivery line. A fluid conduit may be disposed through the neck into the head. The conduit may have a regular shape, such as circular or rectangular, or may have an irregular shape, such as a keyhole or cross shape. The conduit may have one or more widening channels that widen the conduit. The conduit may deliver fluid into a cavity in the head through one or more apertures that may be substantially smaller than the conduit to pressurize the fluid. Preferably, the intersection of the widening channels with the cavity produce the apertures. An occluder may be disposed within the cavity. The occluder, which may be integral with the head, may be configured to receive and cooperate with an atomizing insert having an aperture through which the fluid is ejected as a fine mist. The occluder may be narrower than the inner width of the insert, creating a gap between the occluder and the insert into which the fluid flows. The occluder may have a convex top surface that cooperates with the insert to create narrowing channels that further pressurize the fluid before the fluid reaches the ejection aperture.

The described integral designs provide a desirable mist of fluid through a nozzle that has no moving parts and, being plastic, is highly resistant to cracking and corrosion. In operation, a fluid, preferably water, travels from the fluid delivery line of the misting system through the conduit and widening channels. At the intersection of the widening channels and the cavity, the pressure of the fluid increases as the volume of fluid in the conduit is pushed through the smaller apertures. At a high velocity, the fluid fills the gap between the occluder and the insert and passes into the narrowing channels at the top of the occluder. The fluid pressure is further increased, until the fluid reaches the ejecting aperture and is atomized.

### BRIEF DESCRIPTION OF THE DRAWINGS

FIG. 1 is a top perspective view of a first embodiment of an atomizing nozzle.

FIG. 2 is a top perspective view of a nozzle body in accordance with the first embodiment.

FIG. 3 is a front view of the nozzle body of the first embodiment.

FIG. 4 is a bottom view of the nozzle body of the first embodiment.

FIG. 5 is a top view of the nozzle body of the first embodiment.

FIG. 6 is a cross-sectional front view of the nozzle body of the first embodiment, taken along line 6-6 of FIG. 5.

FIG. 7 is a cross-sectional left side view of the nozzle body of the first embodiment, taken along line 7-7 of FIG. 4.

FIG. 8 is a top perspective view of a nozzle body in accordance with a second embodiment.

FIG. 9 is a top view of an insert in accordance with the first embodiment.

FIG. 10 is a bottom view of the insert of the first embodiment.

FIG. 11 is a cross-sectional front view of the insert of the first embodiment, taken along line 9-9 of FIG. 9.

### DETAILED DESCRIPTION OF THE INVENTION

Referring to FIG. 1, there is illustrated the preferred embodiment of an atomizing nozzle 10 having the improved characteristics described herein. The nozzle 10 may have an integral body 11, the body 11 being described in detail below and configured to receive and retain an atomizing insert 12 that has an ejection aperture 70 that ejects the atomized fluid. In one embodiment, the nozzle 10 may be installed in a misting system, such as a “backyard” residential misting system having one or more fluid delivery hoses and one or more emitter interfaces that receive an emitter such as the nozzle 10. Preferably, the nozzle 10 is configured according to one or more standardized dimensions so that the nozzle 10 may be retrofit into existing misting systems. To accomplish this, typically a portion of the nozzle 10 may be a barbed (see FIG. 8) or threaded cylinder having a diameter and thread configuration to match an existing system into which the nozzle 10 is to be installed.

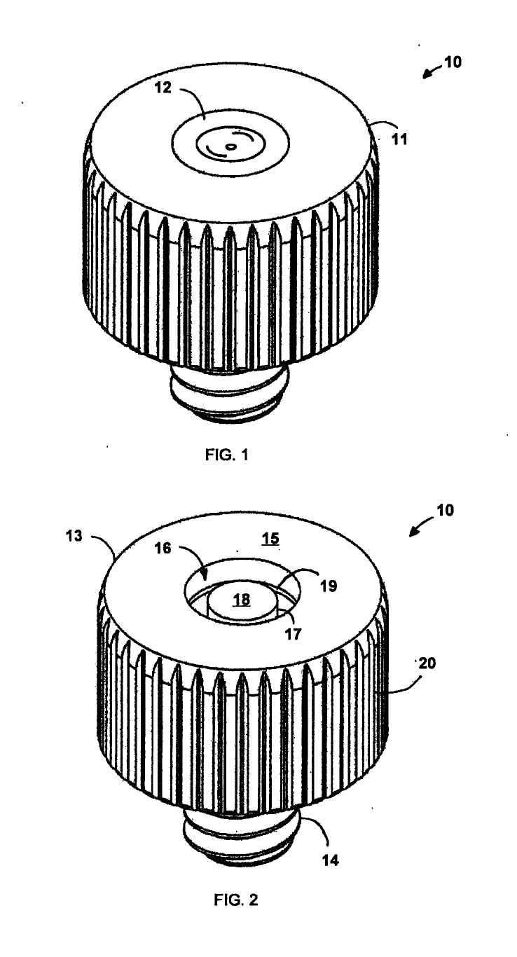

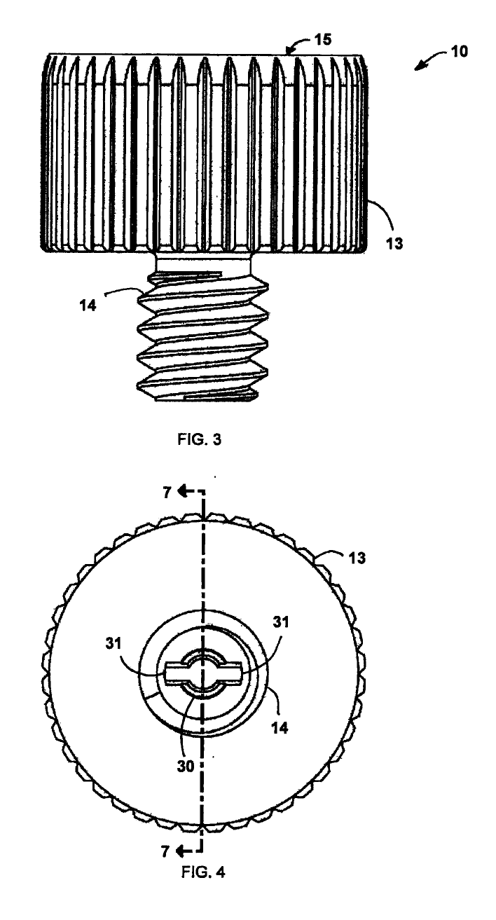

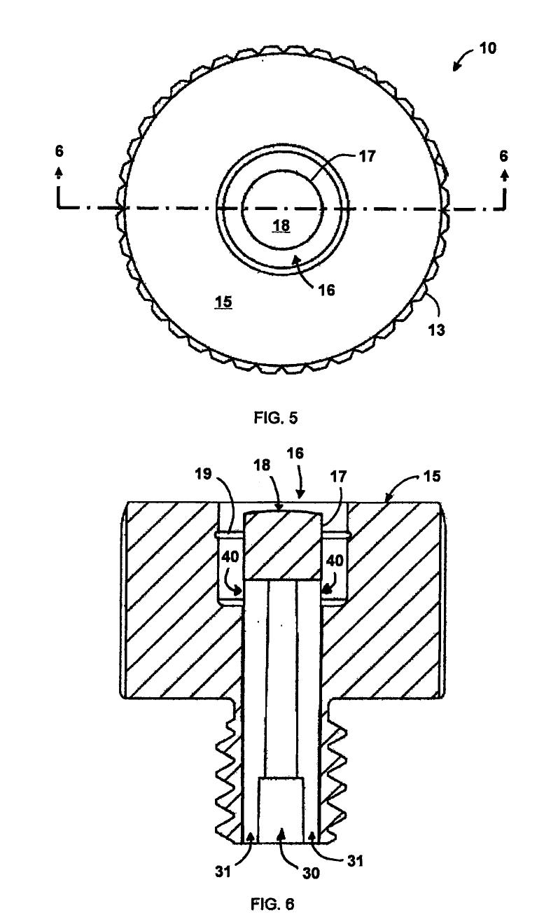

Referring to FIGS. 2-5, the body 11 may be integrally formed, and is preferably molded in a single injection molding or other plastic molding process. The body 11 may be formed of any polymeric material that hardens to a suitable stiffness, such as polyethylene, polyoxymethylene, and the like, as well as various polymer blends. The body 11 may comprise a substantially cylindrical head 13 and a threaded, substantially cylindrical neck 14 extending from the base of the head 13. The head 13 may comprise a rippled or otherwise textured gripping surface 20 extending across some or all of the perimeter of the head 13. The top surface 15 of the head 13 is preferably substantially planar so that the top of the insert is flush with the top surface 15. A cavity 16 may be disposed in the head 13. Preferably, the cavity 16 is cylindrical and centered within the head 13. The cavity 16 receives the insert 12 and may include a groove 19 that cooperates with a notch on the insert 12 to retain the insert 12 within the cavity 16.

A fluid conduit 30 may be disposed through the neck 14 and configured to convey fluid from the delivery hose to the cavity 16. The conduit 30 may have a uniform width along its length, but preferably the conduit 30 narrows as it progresses toward the cavity 16, in order to increase the fluid pressure within the conduit 30. The conduit 30 may have any cross-sectional shape suitable for conveying fluid from the delivery hose to the cavity 16, such as circular, rectangular, oblong, keyhole shaped, or otherwise irregularly shaped. Preferably, the conduit 30 is circular. The conduit 30 may further have one or more widening channels 31 that widen the conduit 30 in one or more directions. The widening channels 31 may, and preferably do, intersect the cavity 16 as described below. A widening channel 31 may have uniform dimensions along its length, but preferably the widening channel 31 narrows in at least one direction as it approaches the cavity 16 in order to increase the fluid pressure in the conduit 30.

The body 11 may further comprise an occluder 17 integral with the head 13 and disposed within the cavity 16. The occluder 17 may project from the bottom of the cavity 16 toward the top surface 15 of the head 13. The occluder 17 may be configured to cooperate with the insert 12. In particular, the insert 12 fits around the occluder 17 and comes very close to the top surface 18 of the occluder 17 but preferably does not touch the top surface 18. Preferably, the top surface 18 is slightly convex to reduce the space between the top surface 18 and the insert 12, which further increases the fluid pressure while breaking up the fluid flow to improve atomization. Further, the insert 12 preferably does not touch the sides of the occluder 17, leaving a slight gap into which the fluid flows as described below. This close cooperation of the occluder 17 with the insert 12 further pressurizes the fluid while it is in the cavity 16.

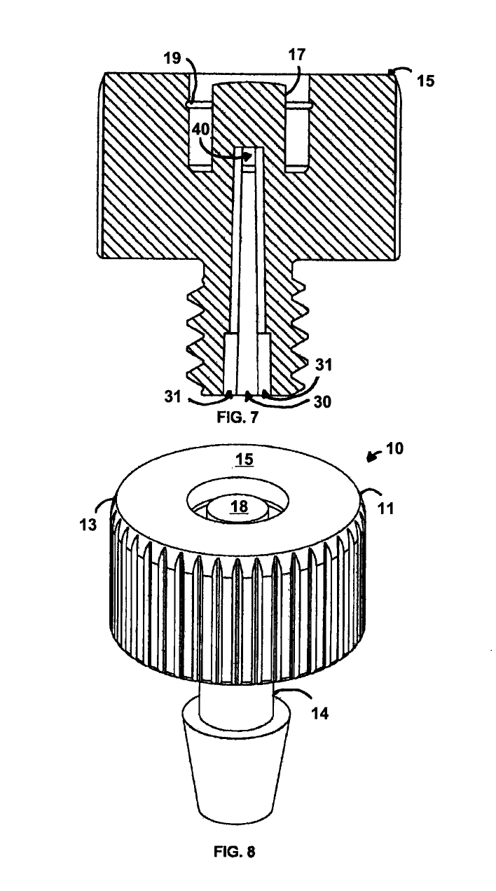

Referring to FIGS. 6 and 7, the conduit 30 extends into the cavity 16 but preferably is retained within the occluder 17, which may be coaxial with the conduit 30. However, together with the widening channels 31, the conduit 30 at its widest point may be wider than the occluder 17. Thus, where the conduit 30 extends into the cavity 16, the widening channels 31 may open one or more apertures 40 into the cavity 16. The apertures 40 may be cross-sectionally smaller than the conduit 30, so that fluid pressure and flux are increased and the fluid passes into the cavity 16 at a higher velocity. With the insert 12 press-fit into the cavity 16, the fluid flows through the conduit 30 and apertures 40 into the cavity 16, filling the gap between the insert 12 and occluder 17. The fluid then flows over the top surface 18 of the occluder 17, where the flow is further compressed until it begins to break apart.

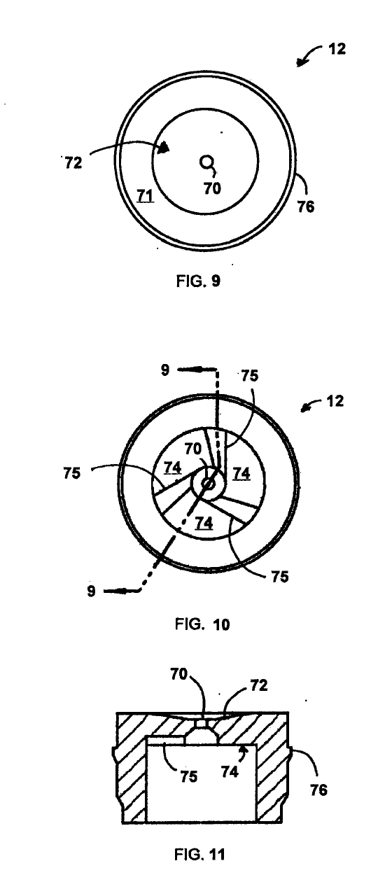

FIGS. 9-11 illustrate an example insert 12 that may be used with the described nozzle bodies. The top surface 71 is flush with the top surface 15 of the head 13 when the insert 12 is in place. A depressed region 72 surrounds the ejection aperture 70 to partially direct the mist as it is ejected from the nozzle. A notch 76 maybe disposed around the circumference of the insert 12. The notch 76 cooperates with the groove 19 to hold the insert 12 in place in the cavity 16. Inside the insert 12, one or more radial channels 75 may be etched into the top inner surface 74 of the insert 12. The radial channels 75 direct the fluid flow in the cavity 16 toward the ejection aperture 70. The radial channels preferably narrow as they approach the ejection aperture 70. This configuration, in conjunction with the convex top surface 18 of the occluder 17, serves to break up the fluid flow and allow the desired atomization to take place without the need for a moving impeller.

To create the preferred amount of mist, the gap between the insert 12 and the occluder 17 is about 5-10 mil wide, decreasing to about 1 mil wide at the top surface 18 of the occluder 17. The preferred head 13 is about 0.29 inches tall, and the preferred occluder 17 projects about 0.274 inches above the bottom surface of the head 13 and has a top surface 18 curved outward at a radius of about 0.328 inches.

The present invention has been described in terms of one or more preferred embodiments, and it should be appreciated that many equivalents, alternatives, variations, and modifications, aside from those expressly stated, are possible and within the scope of the invention.

What is claimed is:

1. A nozzle for atomizing a fluid, the nozzle comprising:
a body cast as a unitary plastic article and comprising:
a substantially cylindrical neck;
a head integral with the neck and having a cavity that receives an atomizing insert;
an occluder integral with the head and positioned within the cavity such that the insert fits over the occluder and leaves a gap between the insert and the occluder;
a fluid conduit disposed through the center of the neck and extending from an end of the neck that can be inserted into a fluid delivery line, to the cavity of the head, the fluid conduit narrowing at it approaches the cavity; and
one or more apertures from the fluid conduit into the cavity, the apertures being in fluid communication with the gap between the insert and the occluder.

2. The nozzle of claim 1, wherein the neck is threaded.

3. The nozzle of claim 1, wherein the head is cylindrical and has a substantially planar top surface with which a top of the insert is flush.

4. The nozzle of claim 1, wherein the cavity is cylindrical and has a bottom, and where the occluder projects from the bottom of the cavity.

5. The nozzle of claim 4, wherein the occluder is cylindrical and coaxial with the cavity.

6. The nozzle of claim 5, wherein the occluder has a convex top surface that cooperates with the insert to gradually reduce the space between the top surface and the insert.

7. The nozzle of claim 6, wherein the insert has an aperture that is coaxial with the occluder.

8. The nozzle of claim 5, wherein the fluid conduit is coaxial with the occluder and extends into the cavity and is retained by the occluder.

9. The nozzle of claim 8, wherein the fluid conduit comprises one or more widening channels, one or more of the widening channels extending out of the occluder such that one or more of the apertures is formed by one or more of the widening channels.

10. The nozzle of claim 9, wherein the one or more widening channels extend along the entire length of the fluid conduit.

11. The nozzle of claim 9, wherein one or more of the widening channels narrows in at least one direction as it approaches the cavity.

12. The nozzle of claim 1, wherein the fluid conduit has a circular cross-section.

13. The nozzle of claim 1, wherein each of the apertures is smaller in cross-section than the fluid conduit at the point of intersection between the fluid conduit and the apertures.

14. The nozzle of claim 1, wherein the body breaks up fluid flow from the fluid delivery line through the nozzle without a moving impeller.

15. A nozzle for atomizing a fluid, the nozzle comprising:
a plastic head having a cavity;
an occluder attached to the head and disposed within the cavity, the occluder having no moving parts;
a plastic neck attached to the head and insertable into a fluid delivery line;
a fluid conduit disposed in the neck, in fluid communication with the fluid delivery line and with the cavity; and
an atomizing insert insertable into the cavity over the occluder, the insert having an aperture that emits fluid from within the cavity as a mist.

16. The nozzle of claim 15, wherein the fluid conduit extends into the cavity and is retained by the occluder, and forms one or more apertures through the occluder into the cavity.

17. The nozzle of claim 16, wherein the fluid conduit narrows as it approaches the cavity.

18. The nozzle of claim 16, further comprising a gap between the insert and the occluder and in fluid communication with the one or more apertures of the fluid conduit and the aperture of the insert, the gap being at least 5 mil wide at the one or more apertures of the fluid conduit and decreasing to about 1 mil wide at a top surface of the occluder.

19. The nozzle of claim 18, wherein the top surface of the occluder is curved outward to reduce the gap to about 1 mil.
